(19) United States
(12) Patent Application Publication
(10) Pub. No.: US 2007/0222684 A1
(43) Pub. Date: Sep. 27, 2007

(54) MULTIPLE LAYER ANTENNA FOR WIRELESS APPLICATIONS

(75) Inventor: Philip P. Kwan, Beaverton, OR (US)

Correspondence Address: MARGER JOHNSON & MCCOLLOM, P.C., 210 SW MORRISON STREET, SUITE 400, PORTLAND, OR, 97204, US

(73) Assignee: CYPRESS SEMICONDUCTOR CORP., San Jose, CA (US)

(21) Appl. No.: 11/685,582

(22) Filed: Mar. 13, 2007

Related U.S. Application Data
(60) Provisional application No. 60/784,547, filed on Mar. 21, 2006.

(51) Int. Cl. H01Q 1/38; H01Q 1/36

(52) U.S. Cl. 343/700 MS; 343/895

(57) ABSTRACT

System and method for a multi-layer antenna is shown and described. A multi-layer antenna includes a plurality of antenna layers that are stacked and aligned to minimize an antenna footprint without degrading electrical performance. This reduced antenna footprint allows system designer the ability to reduce the overall size of wireless communication devices incorporating the multi-layer antenna.

### RELATED APPLICATIONS

This application claims priority from U.S. Provisional Application No. 60/784,547, filed Mar. 21, 2006, which is incorporated herein by reference.

### FIELD OF THE INVENTION

This invention relates generally to wireless communication applications, and more specifically, to multiple layer antennas for wireless communication applications.

### BACKGROUND OF THE INVENTION

Most devices that communicate wirelessly include one or more antennas to transmit and receive wireless signals. For instance, during wireless data transmissions, antennas convert electrical signals into electromagnetic fields, which wirelessly radiate to remote communication devices. This conversion between electrical signals and electromagnetic fields is highly dependent upon the physical structure and resonance behavior of the antennas. As is common in communication fields, there is a ubiquitous desire to reduce the size of communication systems without diminishing electrical performance. This task, however, proves exceedingly difficult, as physical reductions to the antennas often alters their resonance behavior, which in turn degrades wireless communications.

FIG. 1 shows a communication system 100. Referring to FIG. 1, the communication system 100 includes an antenna 110 for communicating wirelessly. The antenna 110 is a metal trace formed on a top face of a printed circuit board (PCB) 120, and designed to have a resonance behavior optimized for a predetermined wireless signal frequency. The antenna 110 converts electrical signals from circuitry 130 into the electromagnetic fields and transmits the electromagnetic fields as wireless signals. The antenna 110 also receives electromagnetic fields and converts them into electrical signals for the circuitry 130. The circuitry 130 exchanges the electrical signals with the antenna 110 through an antenna interface 140. Although antenna 110 adequately transmits and receives wireless signals, the footprint that the antenna 110 requires on the PCB 120 limits the ability of system designers to reduce the overall size of the communication system 100. Since the footprint of the antenna 110 consumes a significant portion of the PCB 120, the need remains for an antenna with a reduced footprint that does not degrade electrical performance.

### DESCRIPTION OF THE DRAWINGS

The invention may be best understood by reading the disclosure with reference to the drawings.

FIG. 1 is a block diagram of a communication system.

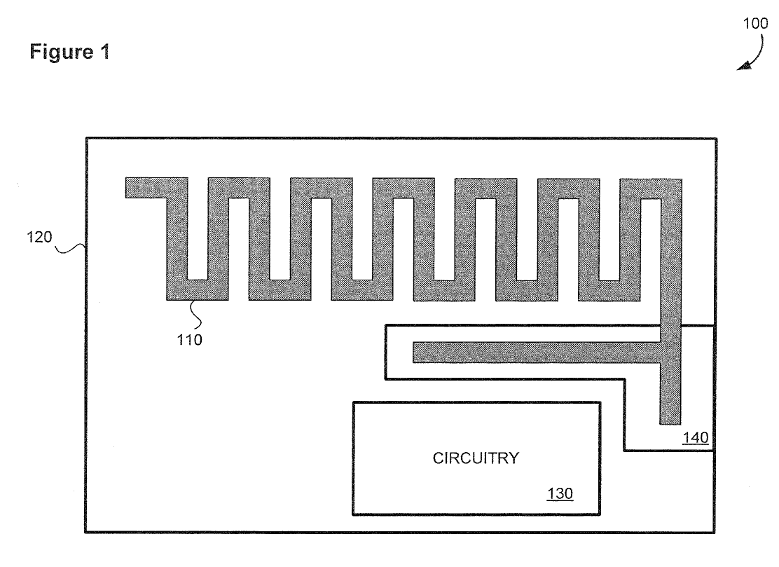

FIGS. 2-4 are block diagrams of embodiments of a wireless communication device.

FIG. 5 is a flowchart of the wireless communication device shown in FIGS. 2-4.

### DETAILED DESCRIPTION

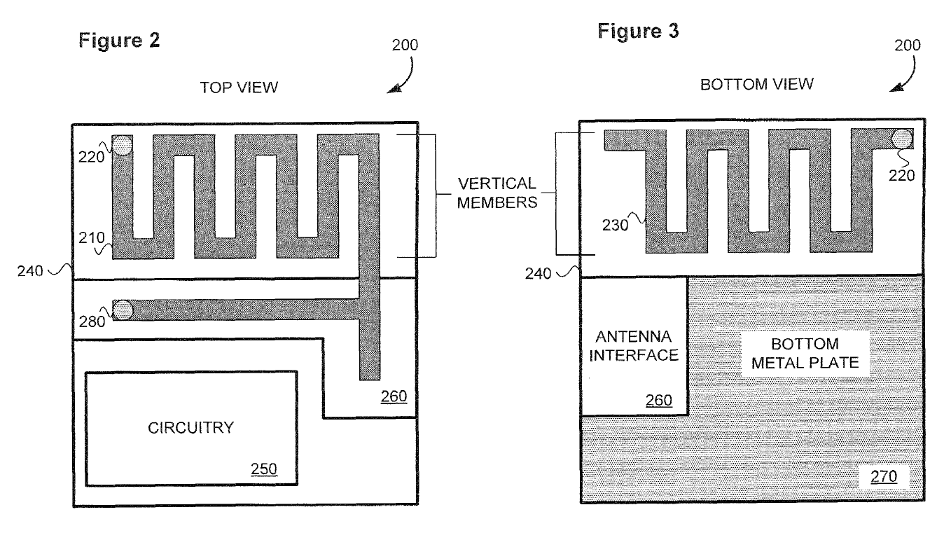

FIGS. 2-4 are block diagrams of embodiments of a wireless communication device 200. Specifically, FIG. 2 shows a top view embodiment of the wireless communication device 200, FIG. 3 shows a bottom view embodiment of the wireless communication device 200, and FIG. 4 shows a cross-sectional side view embodiment of the wireless communication device 200.

Referring to FIGS. 2-4, the wireless communication device 200 includes a multi-layer antenna for transmitting and receiving wireless communications. The multi-layer antenna includes a first antenna layer 210 and a second antenna layer 230. The first and second antenna layers 210 and 230 may have a resonance behavior that optimizes wireless transmissions and receptions at a predetermined signal frequency.

The first antenna layer 210 may be formed on a top surface of a base 240 and a second antenna layer 230 may be formed on a bottom surface of the base 240. For instance, the first and second antenna layers 210 and 230 may be configured in a stack with the base 240 separating the antenna layers 210 and 230. By stacking the first and second antenna layers 210 and 230, the multi-layer antenna has a reduced footprint or requires a base 240 with less surface area. Although FIGS. 2-4 show two antenna layers 210 and 230 formed on opposite sides of the base 240, some embodiments may include more than two antenna layers and/or form them on various sides or portions of the base 240.

The first and second antenna layers 210 and 230 are preferably aligned, e.g., according to their vertical members, allowing electrical signals to propagate in same direction through the vertical members. This alignment of the first and second antenna layers 210 and 230 may prevent cancellation of wireless signals generated by first and second antenna layers 210 and 230 due to destructive interference.

An antenna inter-connector 220 couples the first and second antenna layers 210 and 230 through the base 240. The antenna inter-connector 220 may be a conducting via that allows electrical signals to pass between the first and second antenna layers 210 and 230. The first and second antenna layers 210 and 230 may be metal traces or any other medium capable of transmitting and/or receiving wireless signals. The base 240 may be a printed circuit board (PCB) or any other medium capable of coupling the multi-layer antenna.

The base 240 may include a bottom metal plate 270 on the bottom surface that may be coupled to circuitry 250 and the first antenna layer 210. The first antenna layer 210 may couple to the base 240 with at a connection point 280. The connection point 280 may be a conducting via that electrically couples the first antenna layer 210 to a ground.

The wireless communication device 200 includes circuitry 250 for exchanging electrical signals with the first antenna layer 210 through an antenna interface 260. During wireless transmissions, the circuitry 250 provides electrical signals to the first antenna layer 210 through the antenna interface 260, where the first and second antenna layers 210 and 230 convert the electrical signals into wireless signals for transmission. The first and second antenna layers 210 and 230 convert the electrical signals into wireless signals according to the resonance behavior of the multi-layer antenna. In some embodiments, the first and second antenna layers 210 and 230 may convert the electrical signals into electromagnetic field signals that radiate wirelessly from the first and second antenna layers 210 and 230.

During wireless reception, the first and second antenna layers 210 and 230 receive wireless signals, convert them into electrical signals, and provide them to the circuitry 250 through the antenna interface 260. In some embodiments, the first and second antenna layers 210 and 230 may convert electromagnetic field signals into the electrical signals. The first and second antenna layers 210 and 230 convert the wireless signals into electrical signals according to the resonance behavior of the multi-layer antenna. The wireless communication device 200 may be any device or located within any device that communicates wirelessly, such as USB modules or peripheral devices, cell phones, computers, personal digital assistants (PDAs), etc.

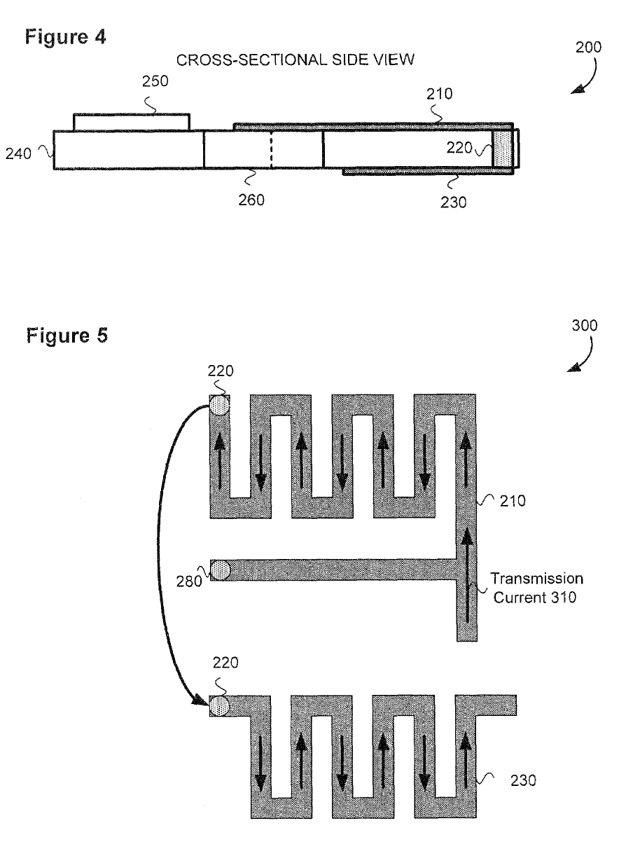

FIG. 5 is a flowchart of the wireless communication device 200 shown in FIGS. 2-4. Referring to FIG. 5, when transmitting wireless signals with a multi-layer antenna, a first antenna layer 210 receives electrical signals in the form of a transmission current 310 and converts the electrical signals into wireless signals. The first antenna layer 210 may receive the transmission current 310 from the circuitry 250 (FIGS. 2 and 4) via the antenna interface 260 (FIGS. 2-4). The antenna interface 260 may also include a connection point 280 that may couple the first antenna layer 210 to a ground.

This electrical-to-wireless signal conversion occurs by propagating the transmission current 310 through the first and second antenna layers 210 and 230, where the resonance behavior of the antenna layers 210 and 230 generates electromagnetic field signals. These electromagnetic field signals radiate wirelessly from the first and second antenna layers 210 and 230.

In some embodiments, each antenna layer 210 and 230 generates an electromagnetic field signal from the electrical signals. Accordingly, the wireless communication device 200 may minimize transmission-field interference between these multiple electromagnetic field signals according to the physical alignment of the first and second antenna layers 210 and 230 and the flow of the transmission current 310 along their vertical members.

The transmission current 310 flows between the two antenna layers 210 and 230 through the antenna inter-connector 220. To avoid possible far-field cancellation of the electromagnetic field signals generated by the first and second antenna layers 210 and 230, the first and second antenna layers 210 and 230 are aligned according to their vertical members. This alignment of the first and second antenna layers 210 and 230 allows the transmission current 310 to propagate in same direction through the vertical members, thus minimizing constructive interference between electromagnetic fields generated and transmitted by the first and second antenna layers 210. Although FIG. 5 shows a transmission current flow embodiment, the first and second antenna layers 210 and 230 may induce a current flow that is similarly aligned, yet in the opposite direction, responsive to the reception of wireless signals.

By utilizing multiple sides of the base 240 and intelligently aligning current flow through the first and second antenna layers 210 and 230, embodiments of the present invention may reduce an antenna footprint without degrading electrical performance. Thus, the addition of a multi-layer antenna allows system designers the freedom to reduce the overall size of their wireless communication devices.

One of skill in the art will recognize that the concepts taught herein can be tailored to a particular application in many other advantageous ways. In particular, those skilled in the art will recognize that the illustrated embodiments are but one of many alternative implementations that will become apparent upon reading this disclosure. For instance, the configuration of the first and second antenna layers 210 and 230 shown and described above is one of many embodiments for multiple layer antennas. Those skilled in the art will recognize various multi-layer antenna implementations.

The preceding embodiments are exemplary. Although the specification may refer to “an”, “one”, “another”, or “some” embodiment(s) in several locations, this does not necessarily mean that each such reference is to the same embodiment(s), or that the feature only applies to a single embodiment.

1. A device comprising:
a first antenna layer coupled to a first side of a base; and
a second antenna layer coupled to a second side of the base and the first antenna layer, the first and second antenna layers configured to at least transmit or receive wireless signals.

2. The device of claim 1 including an inter-connecter to electrically couple first and second antenna layers through the base and a ground connection to electrically couple first antenna layer through the base to a grounding plate.

3. The device of claim 1 including electrical circuitry coupled to the first antenna layer, the electrical circuitry to provide a transmission current to the first antenna layer, where the first antenna layer is configured to propagate the transmission current to generate the wireless signals.

4. The device of claim 3 where the first antenna layer is configured to propagate the transmission current to the second antenna layer, where the second antenna layer is configured to propagate the transmission current to generate the wireless signals.

5. The device of claim 4
where the first antenna layer includes multiple vertical members, and the second antenna layer includes multiple vertical members which are in substantial alignment with the vertical members associated with the first antenna layer; and
where the transmission current propagates in substantially the same direction in vertical members of the first and second antenna layers.

6. The device of claim 1 including electrical circuitry coupled to the first antenna layer, where the first and second antenna layers generate a reception current responsive to wireless signals and propagate the reception current to the electrical circuitry.

7. The device of claim 2
where the first antenna layer includes multiple vertical members, and the second antenna layer includes multiple vertical members which are in substantial alignment with the vertical members associated with the first antenna layer; and
where the reception current propagates in substantially the same direction in vertical members of the first and second antenna layers.

8. A device comprising:
a multi-layer antenna configured to at least transmit or receive wireless signals, the multi-layer antenna including a plurality of antenna layers each to propagate electrical signals in substantially the same direction when transmitting or receiving the wireless signals.

9. The device of claim 8 including an antenna inter-connector to couple two or more antenna layers.

10. The device of claim 8 where each antenna layer includes one or more vertical members, where the vertical members of one antenna layer are aligned with corresponding vertical members from at least another antenna layer.

11. The device of claim 10 where the antenna layers are configured to propagate the electrical signals through the aligned vertical members in substantially the same direction when transmitting or receiving the wireless signals.

12. The device of claim 8 including a ground connection to electrically couple at least one antenna layer to a grounding plate.

13. The device of claim 8 including electrical circuitry coupled to at least one of the antenna layers, where the antenna layers generate wireless signals by propagating a transmission current received from the electrical circuitry.

14. The device of claim 13 where the antenna layers generate a reception current responsive to wireless signals and propagate the reception current to the electrical circuitry.

15. The device of claim 14 where the transmission current and the reception current propagate through the antenna layers in the opposite direction.

16. A method comprising:
propagating a electrical current through a first antenna layer;
transferring the electrical current to a second antenna layer through a connecting via; and
propagating the electrical current through the second antenna layer, where the first and second antenna layers coupled to opposite sides of a base and are in substantial alignment.

17. The method of claim 16
receiving the electrical current from an electrical circuitry; and
generating wireless signals responsive to the propagation of the electrical current through the first and the second antenna layers.

18. The method of claim 17 where the first and second antenna layers are configured to reduce interference when transmitting the wireless signals.

19. The method of claim 16 including
receiving wireless signals with at least the first or the second antenna layers; and
generating the electrical current responsive to the wireless signals.

20. The method of claim 16
where the first antenna layer includes multiple vertical members, and the second antenna layer includes multiple vertical members which are in substantial alignment with the vertical members associated with the first antenna layer; and
where the electrical current propagates in substantially the same direction in vertical members of the first and second antenna layers.
